(19) United States
(12) Patent Application Publication
(10) Pub. No.: US 2022/0314858 A1
(43) Pub. Date: Oct. 6, 2022

(54) Vehicle Accessory Anchor System

(71) Applicant: Gregory Serpis, Hampton, NH (US)

(72) Inventor: Gregory Serpis, Hampton, NH (US)

(21) Appl. No.: 17/221,252

(22) Filed: Apr. 2, 2021

(51) Int. Cl. B60N 3/00; B60N 3/10; B60R 16/03

(52) U.S. Cl. CPC B60N 3/00; B60N 3/102; B60R 16/03

(57) ABSTRACT

A vehicle accessory anchor system is provided. The system involves a shaft or similar elongate connector which is monolithically connected to a frame of the vehicle. On an opposite side of the shaft is a connector port which extends to or through an interior finish of the vehicle. The connector port allows connection of a variety of accessories such as device holders, and the like. As such, the vehicle accessory anchor system overcomes problems of prior art accessory connectors by securely tying in the accessory to the frame of the vehicle.

### BACKGROUND

### Technical Field

The present disclosure relates generally to accessory connecting devices. More particularly the present disclosure relates to an accessory anchor system for vehicles which is directly connected to the frame and allows removable connection of an accessory such as a cellular phone holder, cup holder, accessories providing additional storage and/or organization to the vehicle interior, and the like.

### Description of Related Art

With the proliferation of smart cellular telephones, tablet computers, and the general increase of mobile computing capability, it has become very commonplace for drivers to mount their devices somewhere in a vehicle. This is particularly useful for using a phone or tablet as a navigation system, and also for safe mobile calling and the like.

Removable connectors for mobile devices which connect via adhesive, suction, clamps, and the like have existed for some time. However, these devices suffer from substantial weaknesses including that they can permanently damage or otherwise mark interior surfaces, fail to stay in place-making them unreliable, and are otherwise inconvenient and insecure.

Therefore, what is needed is a system that can allow for connection of accessories in a secure and reliable manner without damaging or otherwise impacting the interior finish of the vehicle.

### SUMMARY

The subject matter of this application may involve, in some cases, interrelated products, alternative solutions to a particular problem, and/or a plurality of different uses of a single system or article.

In one aspect, a vehicle having an accessory anchor system built into, i.e. connected to or tied back to, the frame of the vehicle is provided. The vehicle has a frame, with the frame forming a supporting structure for the vehicle.

A vehicle accessory anchor, formed in this aspect as an elongate shaft is connected directly to the frame at a distal end. A proximal end of the shaft extends to a vehicle interior. The proximal end of the shaft comprises a connector port allowing connection of an accessory.

Another aspect includes the vehicle having the accessory anchor system as an assembly having an accessory connected to the connector port, thereby effectively tying the accessory into the frame of the vehicle.

In yet another aspect, a method of assembling a motor vehicle is provided. The method involves assembling a frame of the motor vehicle. The method further includes connecting a vehicle accessory anchor to the frame of the motor vehicle. The vehicle accessory anchor is made of an elongate shaft which is connected directly to the frame at a distal end. A vehicle interior is connected to the frame such that the shaft extends to the vehicle interior at its proximal end. This proximal end of the shaft has a connector port allowing connection of an accessory.

### BRIEF DESCRIPTION OF THE DRAWINGS

FIG. 1 provides an elevation view of a vehicle having a plurality of vehicle accessory anchor systems connected to its frame and extending into the vehicle's interior finish.

FIG. 2 provides a detail view of an embodiment of the vehicle accessory anchor system.

FIG. 3 provides a detail view of another embodiment of the vehicle accessory anchor system.

FIG. 4 provides a view of an interior finish of a vehicle having an accessory mounted to the vehicle accessory anchor system.

FIG. 5 provides a view of an embodiment of a connector port of the vehicle accessory anchor system.

FIG. 6 provides a view of another embodiment of a connector port of the vehicle accessory anchor system.

FIG. 7 provides a detail view of yet another embodiment of the vehicle accessory anchor system.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a vehicle accessory anchor system. The anchor system involves a shaft or similar elongate connector directly connected to a frame of a vehicle with the other opposite end extends to an interior of the vehicle. The end of the elongate connector extending to the interior of the vehicle has a port or other connection structure to allow an accessory to be connected to the elongate via this port. In some embodiments, the elongate connector may be monolithically formed with the frame of the vehicle. As assembled, the system allows for an extremely secure and reliable connection of accessory directly to the frame of the vehicle. The present disclosure solves the problem of the prior art systems which are insecurely connected to a surface of the interior or which use permanent and damaging adhesive to bond to the interior of the vehicle. When not in use, in some embodiments, a cap or cover may be placed over the connector port to hide it.

The term frame as used herein refers to the vehicle frame, as well as one or more vehicle subframes attached to the frame. Further, a vehicle door frame components is also included with the use of the term frame.

The anchor disclosed herein, but virtue of its connection to the vehicle frame, may be designed to support and hold a substantial amount of weight. In one embodiment, the anchor may be configured to support and hold at least a 20 lb load. In another embodiment, the anchor may be configured to support and hold at least a 50 lb load. In yet still another embodiment, the anchor may be configured to support and hold at least a 100 lb load. In another embodiment, the anchor may be configured to support and hold at least a 250 lb load. Of course, different configurations and embodiments may support and hold less or more weight, without straying from the scope of this invention.

The vehicle accessory anchor system may be operable to receive any number of different accessories without straying from the scope of the invention. Accessories contemplated herein include, but are not limited to accessories such as a cellular phone holder, cup holder, a communications system, a wireless charger, accessories providing additional storage and/or organization to the vehicle interior, a table or platform, and the like. Of course, other accessories may be attached to the vehicle accessory anchor system without straying from the scope of this invention. In many embodiments, an accessory holder, mount, or base may be used to connect the accessory to the connector port of the vehicle accessory anchor system.

The shaft or similar elongate connector may be any structure having one end connected to a frame of a vehicle, with another end extending to an interior of the vehicle. The term “shaft” will be used herein to refer to this element though it may not necessarily be limited to a shaft. The shaft may be formed of any material capable of being connected to the vehicle frame and supporting an accessory connected to it. This may include, but is not limited to, metals, plastics, composite materials, ceramics, wood, combinations of these materials, and the like. Connection of the shaft to the vehicle body may be in any direct manner including, but not limited to, welding, integral molding, bracket connection, bolts or screw connection, slotted connection, and the like.

The connector port may be any structure capable of having an accessory connected thereto. The port may be male or female, threaded, frictional fit, and the like. In some embodiments, the port may be a magnet allowing magnetic connection, in combination with other structure or on its own. In one embodiment, the connector port may be a threaded hole or rod to threaded connect to a corresponding accessory. In another embodiment, the connector port may be a bayonet style connector having a twist lock configuration to connect to a corresponding accessory. In still another embodiment, the connector port may be a quick connect fitting to connect to a corresponding accessory. In still another embodiment, the connector port may be a smooth bore aperture or narrow shaft to be mate with a corresponding bore/shaft of an accessory. Of course, the connection port may be any other connection structures without straying from the scope of this invention.

In some embodiments, the vehicle accessory anchor system may include safety features to prevent it from undesirably extending into the interior of a vehicle in the event of an accident. In one embodiment, the shaft may be connected to the frame such that, upon a bending of the frame, the shaft can pivot or bend about this connection. In another embodiment, the shaft may be crimped to allow for a bending of the shaft about the crimp instead of extending into the vehicle interior. In still another embodiment, the shaft may be collapsible. The collapsible shaft may, for example, be formed of two telescoping parts held in relative position by a tolerance ring which can give way upon application of a predetermined amount of force, allowing the collapsible shaft to telescope and shorten in length.

It is important to note that the vehicle accessory anchor system may be positioned anywhere in the vehicle so long as it connects to the frame at one end, and extends to the interior on another end. Non-limiting examples of location include, but are not limited to: dashboard, center console, ceiling, doors, rear console, floor, and the like. This versatility allows vehicle manufactures to highly customize their vehicles and allow users to connect accessories in any number of locations.

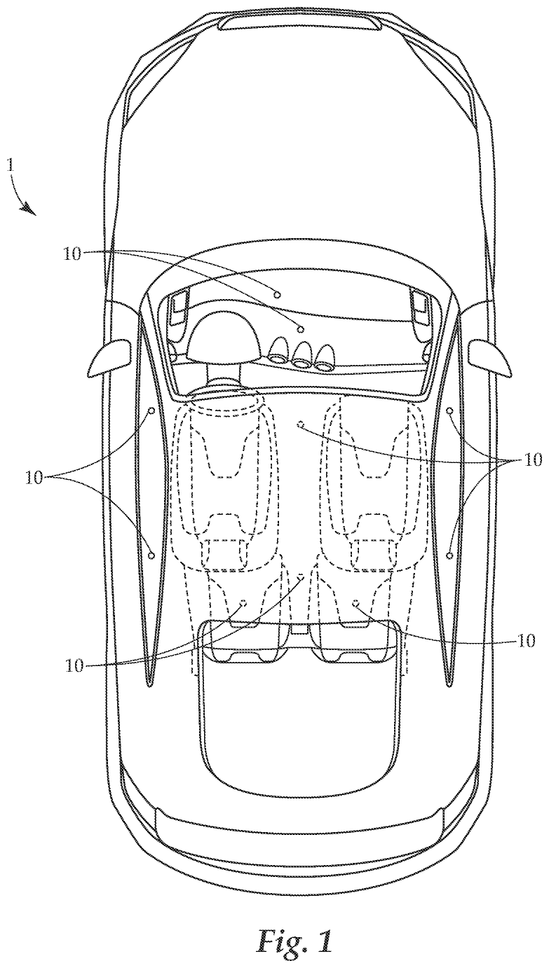

Turning now to FIG. 1, a view of an embodiment having multiple vehicle accessory anchors throughout the vehicle is shown. The vehicle 1 comprises multiple accessory anchors 10 including on the top of the dashboard, front of the dashboard, ceiling above the windshield, in any or all of the doors, center console, and rear console. Of course, as noted above, the vehicle accessory anchors may be positioned anywhere on the interior of the vehicle so long as they are connected to the frame of the vehicle.

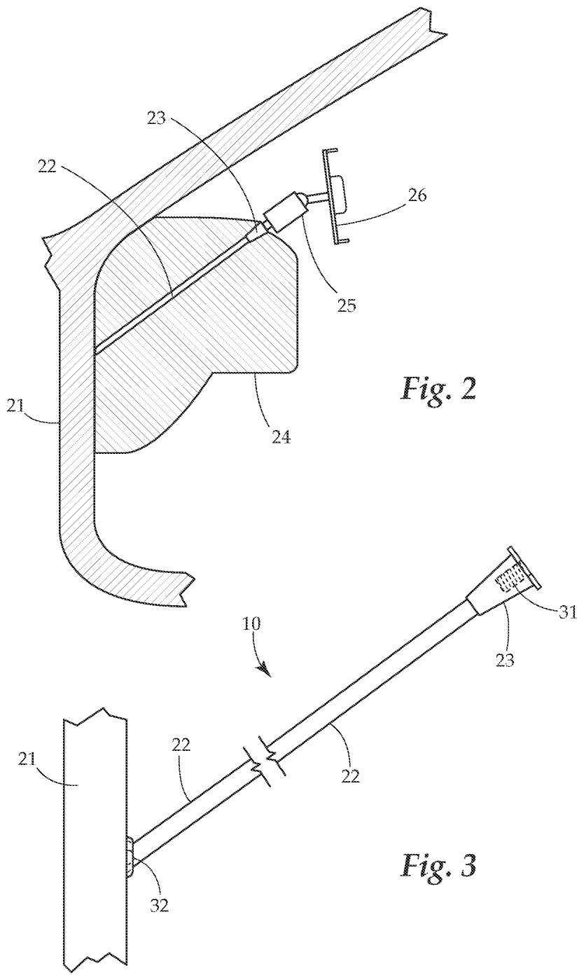

FIG. 2 shows a partial cutaway view of the vehicle having the vehicle accessory anchor. In this view, the frame is visible. The vehicle accessory anchor 10 has shaft 22 which connects directly to the frame 21 at its distal end. At its proximal end is the connector port 23. As noted above, the connector port may be any structure capable of securely receiving a corresponding connector structure. The proximal end of the shaft 22 of the vehicle accessory anchor extends to the vehicle's interior finish 24 such as a dash, console, celling or door panel, and the like. This allows the connector port 23 to be accessible to the user inside the vehicle. An accessory, shown here as a cell phone holder 26 is connected to the connector port 23 at its base 25. As assembled, the accessory is very securely connected to the vehicle frame, ensuring it is safely and reliably held in place.

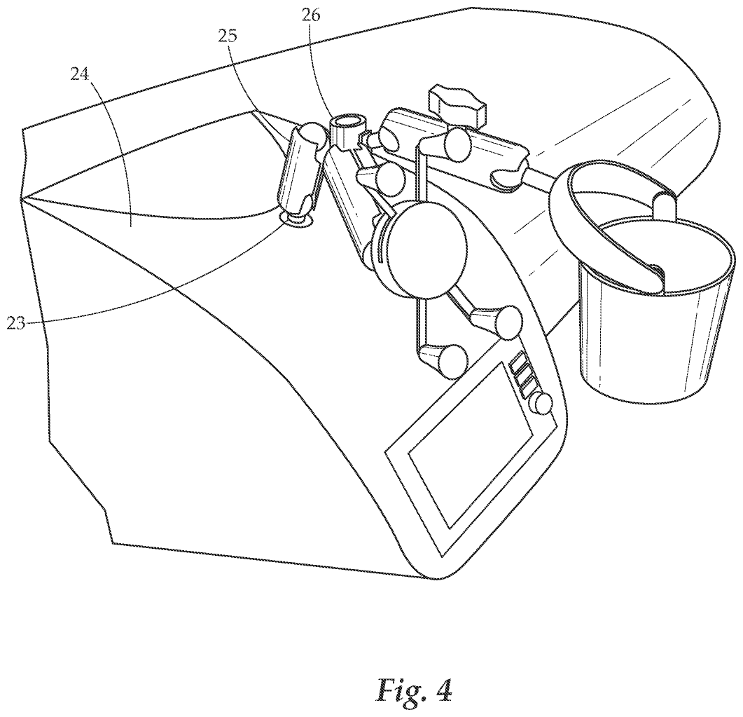

FIG. 3 provides a detail view of the connection of the shaft to the vehicle. Here, shaft 22 is connected to the vehicle frame 21 by a weld 31 effectively integrating the shaft 22 into the vehicle frame 21. Also shown in FIG. 3 is connector port 23, which in this embodiment utilizes a threaded hole 31. However, as noted above, connector port 23 may be any number of different configurations without straying from the scope of this invention.

FIG. 4 provides an interior view of the vehicle having the vehicle accessory anchor system. The connector port 23 extends to the vehicle interior finish 24. Here, a combination mobile device and cup holder accessory 26 is attached to the connector port 23 via base 25. As such, the mobile device and cup holder is effectively integrated into the frame of the vehicle and is held in place very securely.

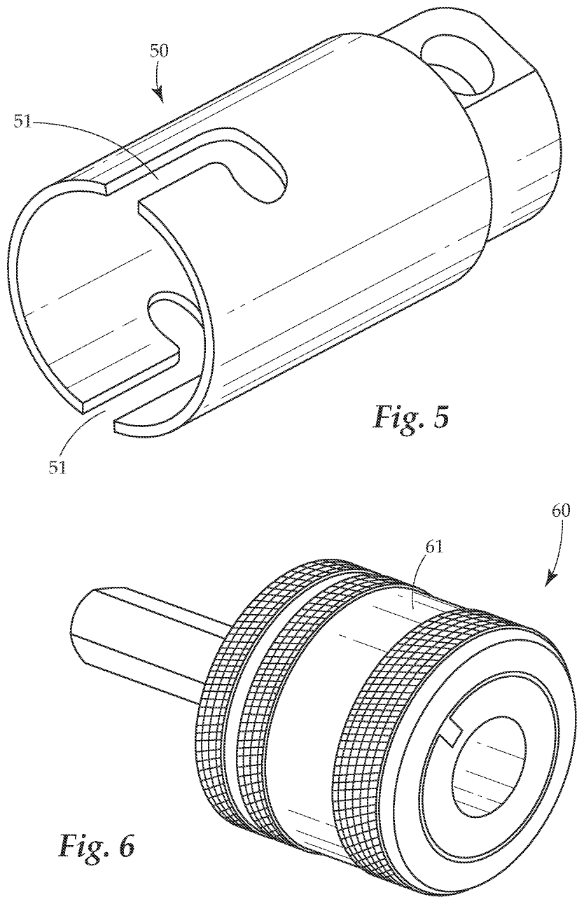

FIG. 5 shows a view of an embodiment of the connector port formed as a bayonet connector. The bayonet connector 50 has two L-shaped slots 51 which engage pins extending from an accessory (not shown). The pins are passed through the lengthwise part of the slot 51 and then twisted to engage with the annular parts of the slot. A hidden spring provides pressure to keep the pins in place. This holds the accessory in place and prevents it from pulling away from the bayonet connector 50 until it is rotated out of the annular portions of the slot 51.

FIG. 6 shows a view of an embodiment of the connector port formed as a quick connect fitting. The quick connect fitting 60 connects to the distal end of the shaft (not show) and mates with a matching male portion of the accessory. The locking collar 61 engages with a plurality of bearings (not shown). A spring urges the collar 61 forward to hold the bearings in place and engaged with the male piece. The collar can be retracted against the spring force, which releases the bearings and allows removal of the male piece of the accessory.

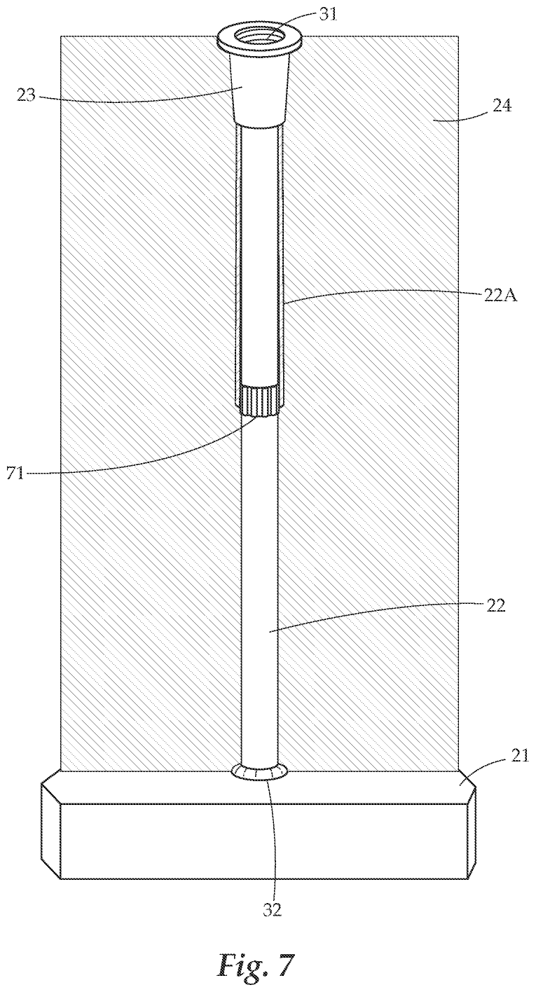

FIG. 7 provides a view of an embodiment of a collapsible shaft of the vehicle accessory anchor. The shaft 22 is formed of a first part 22 and second part 22A. Second part 22A is formed as a hollow shaft having an inner cross section equal to or slightly larger than an outer cross section of the shaft first part 22. Accordingly, second part 22A can slide into first part 22. A tolerance ring 71 connects the first part 22 of the shaft to the second part 22A. The tolerance ring frictionally prevents movement of the second part 22A relative to the first part 22 until a predetermined amount of force is applied, at which point the tolerance ring allows movement of the two so that that the second part 22A can collapse over the first part 22. As such, in a car crash, the shaft can collapse and shorten in length instead of protruding into the vehicle. In one embodiment, the connector port 23 may be connected to the vehicle interior finish 24. Upon a force sufficient, or nearly sufficient, to cause the connector port 23 to separate from and pass through the interior finish, the tolerance ring 71 may be configured to allow collapsing of the shaft, preventing it from passing through the vehicle interior finish 24.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A motor vehicle comprising:
a frame, the frame forming a supporting structure for the vehicle;
a vehicle accessory anchor comprising an elongate shaft, the elongate shaft connected directly to the frame at a distal end, and extending to a vehicle interior at the proximal end, the proximal end of the shaft comprising a connector port allowing connection of an accessory.

2. The motor vehicle of claim 1 wherein the connector port is a threaded opening extending into the shaft.

3. The motor vehicle of claim 1 wherein the connector port is a bayonet style connector.

4. The motor vehicle of claim 1 wherein the connector port is a quick connect fitting.

5. The motor vehicle of claim 1 wherein the proximal end of the shaft is engaged with the vehicle interior.

6. The motor vehicle of claim 1 wherein the shaft comprises a breakaway portion operable to bend upon a predetermined force applied to the proximal or distal end of the shaft.

7. The motor vehicle of claim 1 wherein the shaft is a collapsible shaft and wherein a first part of the collapsible shaft and second part of the collapsible shaft are held in relative position by a tolerance ring frictionally engaged with an outside of the first part of the collapsible shaft and an inside of the second part of the collapsible shaft.

8. The motor vehicle of claim 7 wherein the first part of the collapsible shaft is movable relative to the second part of the collapsible shaft upon application of a predetermined force.

9. The motor vehicle of claim 8 wherein the proximal end of the shaft is engaged with the vehicle interior, and wherein, upon application of the predetermined force between the vehicle interior and the proximal end of the shaft, the first part of the collapsible shaft is movable relative to the second part of the collapsible shaft.

10. The motor vehicle of claim 1 wherein the proximal end of the shaft extends to a vehicle dashboard.

11. The motor vehicle of claim 1 wherein the proximal end of the shaft extends to a vehicle center console.

12. The motor vehicle of claim 1 wherein the proximal end of the shaft extends to a ceiling of the vehicle.

13. The motor vehicle of claim 1 wherein the distal end of the shaft is directly connected to the vehicle frame by a weld.

14. The motor vehicle of claim 1 wherein the distal end of the shaft is monolithically connected to the vehicle frame.

15. A motor vehicle and accessory assembly comprising:
the motor vehicle of claim 1; and
an accessory directly attached to the connector port.

16. The motor vehicle and accessory assembly of claim 15 wherein the accessory is a mobile computing device holder.

17. The motor vehicle and accessory assembly of claim 15 wherein the accessory is a cup holder.

18. The motor vehicle and accessory assembly of claim 15 wherein the accessory is a communications system.

19. The motor vehicle and accessory assembly of claim 15 wherein the accessory is a wireless charger.

20. A method of assembling a motor vehicle comprising:
assembling a frame of the motor vehicle;
connecting a vehicle accessory anchor to the frame of the motor vehicle, the vehicle accessory anchor comprising an elongate shaft, the elongate shaft connected directly to the frame at a distal end;
connecting a vehicle interior to the frame; and
wherein the shaft extending to the vehicle interior at the proximal end, the proximal end of the shaft comprising a connector port allowing connection of an accessory.
